(19) United States
(12) Patent Application Publication
(10) Pub. No.: US 2016/0215125 A1
(43) Pub. Date: Jul. 28, 2016

(54) Rubber Composition and Pneumatic Tire Using Same

(71) Applicant: THE YOKOHAMA RUBBER CO., LTD., Tokyo (JP)

(72) Inventor: Manabu Kato, Hiratsuka-shi, Kanagawa (JP)

(21) Appl. No.: 14/904,678

(22) PCT Filed: Jul. 9, 2014
(86) PCT No.: PCT/JP2014/068310

§ 371 Date: Jan. 12, 2016

(30) Foreign Application Priority Data
Jul. 12, 2013 (JP) 2013-146035
Jul. 12, 2013 (JP) 2013-146192

(51) Int. Cl. C08L 9/00

(52) U.S. Cl. CPC C08L 9/00

(57) ABSTRACT

Disclosed are: a rubber composition having mixed therein from 1 to 2.5 parts by mass of a wax and a polyalkyl methacrylate or a polybutene resin with respect to 100 parts by mass of a diene rubber including a natural rubber; the rubber composition comprising from 0.5 to 3 parts by mass of the polyalkyl methacrylate with respect to 100 parts by mass of the diene rubber including the natural rubber when the polyalkyl methacrylate is mixed therein; the rubber composition comprising from 1.0 to 5.0 parts by mass of the polybutene resin with respect to 100 parts by mass of the diene rubber including the natural rubber when the polybutene resin is mixed therein, a molar ratio of the wax to the polybutene resin being in a range of from 0.8 to 3.2, and a pneumatic tire using the same in side walls.

### TECHNICAL FIELD

The present technology relates to a rubber composition and a pneumatic tire using the same, and more particularly to a rubber composition which does not diminish the characteristics required of tire side walls and which is capable of preventing the occurrence of appearance flaws due to whitening, and a pneumatic tire using the same.

### BACKGROUND

Conventionally a hydrocarbon wax is ordinarily mixed into a rubber composition in order to prevent the cracking of the rubber due to ozone. However, when such a wax is added, it gradually elutes (bleeds) to the surface of the rubber and solidifies after long-term use, which results in problems in that the rubber surface whitens and the appearance is diminished.

Japanese Unexamined Patent Application Publication No. 2007-284522 described below, for example, discloses a rubber composition which contains from 15 to 100 parts by weight of a photocatalyst with respect to 100 parts by weight of a diene rubber and does not contain a wax. In addition, Japanese Unexamined Patent Application Publication No. 2006-328144 discloses a rubber composition which contains a rubber component selected from the group consisting of a natural rubber, a polyisoprene rubber, a polybutadiene rubber, and a styrene-butadiene copolymer rubber and a wax as a core agent and containing a microcapsule prepared by coating the surface of the core agent with a thermoplastic resin with a melting point of 120 to 180° C. as a wax.

However, in today's industry, where there is an intense demand for improvements in tire quality, there is a demand for technology capable of further solving the problem of appearance flaws of tire side walls.

### SUMMARY

The present technology provides a rubber composition which does not diminish the characteristics required of tire side walls and which is capable of preventing the occurrence of appearance flaws due to whitening, and a pneumatic tire using the same.

As a result of conducting dedicated research, the present inventors discovered that the problem described above can be solved by mixing a specific amount of a wax and a specific amount of polyalkyl methacrylate or a polybutene resin into a rubber component of a specific composition, and thus completed the present technology.

Specifically, the present technology is described hereinafter.

1. A rubber composition having mixed therein from 1 to 2.5 parts by mass of a wax and a polyalkyl methacrylate or a polybutene resin with respect to 100 parts by mass of a diene rubber including a natural rubber;

the rubber composition comprising from 0.5 to 3 parts by mass of the polyalkyl methacrylate with respect to 100 parts by mass of the diene rubber including the natural rubber when the polyalkyl methacrylate is mixed therein;

the rubber composition comprising from 1.0 to 5.0 parts by mass of the polybutene resin with respect to 100 parts by mass of the diene rubber including the natural rubber when the polybutene resin is mixed therein; and a molar ratio of the wax to the polybutene resin being in a range of from 0.8 to 3.2.

2. The rubber composition according to (1), wherein a weight average molecular weight of the polyalkyl methacrylate is from 10,000 to 200,000.

3. The rubber composition according to (1), wherein a number of carbon atoms of an alkyl portion of the polyalkyl methacrylate is from 1 to 20.

4. The rubber composition according to (1), wherein a number of carbon atoms of a hydrocarbon contained in a greatest amount in the wax is at most 40.

5. The rubber composition according to (1), wherein a compounded amount of the natural rubber is from 30 to 50 mass % with respect to the entire diene rubber.

6. The rubber composition according to (1), wherein an SP value of the polyalkyl methacrylate is at most 9.3.

7. The rubber composition according to (7), wherein an SP value of the polyalkyl methacrylate is from 8.7 to 9.0.

8. The rubber composition according to (1), wherein a compounded amount of the polyalkyl methacrylate is from 1.0 to 3.0 parts by mass with respect to 100 parts by mass of the diene rubber.

9. The rubber composition according to (1), wherein a weight average molecular weight of the polybutene resin is from 500 to 5,000.

10. The rubber composition according to (9), wherein a weight average molecular weight of the polybutene resin is from 500 to 2,000.

11. The rubber composition according to (1) comprising an oil further mixed into the rubber composition, wherein a compounded amount of the oil, the wax, and the polybutene resin is at most 17 parts by mass with respect to 100 parts by mass of the diene rubber.

12. The rubber composition according to (1), wherein a compounded amount of the polybutene resin is from 1.0 to 2.5 parts by mass with respect to 100 parts by mass of the diene rubber.

13. A pneumatic tire using the rubber composition described in (1) in side walls.

With the present technology, a specific amount of a wax and a specific amount of a polyalkyl methacrylate or a polybutene resin are mixed into a rubber component having a specific composition, so it is possible to provide a rubber composition which does not diminish the characteristics required of tire side walls and which is capable of preventing the occurrence of appearance flaws due to whitening, and a pneumatic tire using the same.

### DETAILED DESCRIPTION

The present technology will be described in further detail hereinafter.

### Diene Rubber

The diene rubber used in the present technology contains a natural rubber (NR) as an essential component. The compounded amount of the NR is preferably from 30 to 50 mass % with respect to the entire diene rubber from the perspective that the effect of the present technology is enhanced. Other diene rubbers in addition to NR may also be used, examples of which include isoprene rubber (IR), butadiene rubber (BR), styrene-butadiene copolymer rubber (SBR), acrylonitrile-butadiene copolymer rubber (NBR), and the like. One of these may be used alone, or two or more may be used in combination. In addition, the molecular mass and a microstructure of the rubber component is not particularly limited and may be terminally modified by an amine, amide, silyl, alkoxysilyl, carboxyl, or hydroxyl group, or the like, or may be epoxidized.

### Wax

The wax used in the present technology is not particularly limited, and any wax that has been conventionally used for the purpose of preventing the cracking of rubber can be used, examples of which include hydrocarbon waxes such as paraffin wax, synthetic paraffin wax, and polyethylene wax. These waxes ordinarily contain hydrocarbons having from 20 to 50 carbon atoms. Of these, the number of carbon atoms of the hydrocarbon contained in the greatest amount in the wax is preferably at most 40 from the perspective that the effect of the present technology is enhanced.

Here, the “number of carbon atoms of the hydrocarbon contained in the greatest amount in the wax” can be determined, for example, from the peak tops of the carbon number distribution of a chromatogram obtained by gas chromatography.

An example of the gas chromatography conditions is as follows:

Gas chromatograph: GC-8A (manufactured by Shimadzu Corporation)

Column: OV-1

Carrier gas: N₂

Oven temperature: 250° C.

Detector: FID

Detector temperature: 250° C.

### Polyalkyl Methacrylate

The polyalkyl methacrylate used in the present technology is a known compound and is commercially available. The number of carbon atoms of the alkyl portion of the polyalkyl methacrylate is preferably from 1 to 20 from the perspective that the effect of the present technology is enhanced. Such a polyalkyl methacrylate is available, for example, from Sanyo Chemical Industries, Ltd. under the trade name Aclube.

In addition, the SP value (solubility parameter) of the polyalkyl methacrylate is preferably at most 9.3 and more preferably from 8.7 to 9.0 from the perspective that the effect of the present technology is enhanced.

Further, the weight average molecular weight (Mw) of the polyalkyl methacrylate is preferably from 10,000 to 200,000 and more preferably from 10,000 to 50,000 from the perspective that the effect of the present technology is enhanced.

The Mw is measured via gel permeation chromatography (GPC) in terms of standard polystyrene.

### Polybutene Resin

The polybutene resin used in the present technology is a known compound and is commercially available. Further, the weight average molecular weight (Mw) of the polybutene resin is preferably from 500 to 5,000 and more preferably from 500 to 2,000 from the perspective that the effect of the present technology is enhanced.

The Mw is measured via gel permeation chromatography (GPC) in terms of standard polystyrene.

Such a polybutene resin is commercially available from JX Nippon Oil & Energy Corporation as the HV Series, for example.

According to the research of the present inventors, it is assumed that polyalkyl methacrylate and polybutene resins act to prevent the side wall surface from whitening by suppressing the crystallization of a wax that has bled onto the side wall surface and closely adhering to the surface.

### Filler

The rubber composition of the present technology may be compounded with various fillers in addition to the components described above. The filler is not particularly limited and may be selected as necessary in accordance with the application thereof, but examples thereof include carbon black, silica, and inorganic fillers. Examples of inorganic fillers include clay, talc, calcium carbonate, and the like.

### Compounding Ratio of the Rubber Composition

The rubber composition of the present technology has mixed therein from 1 to 2.5 parts by mass of a wax and a polyalkyl methacrylate or a polybutene resin with respect to 100 parts by mass of a diene rubber including a natural rubber;

the rubber composition comprising from 0.5 to 3 parts by mass of the polyalkyl methacrylate with respect to 100 parts by mass of the diene rubber including the natural rubber when the polyalkyl methacrylate is mixed therein;

the rubber composition comprising from 1.0 to 5.0 parts by mass of the polybutene resin with respect to 100 parts by mass of the diene rubber including the natural rubber when the polybutene resin is mixed therein; and a molar ratio of the wax to the polybutene resin being in a range of from 0.8 to 3.2.

When the compounded amount of the wax is less than 1 part by mass, it is not possible to prevent the cracking of the rubber due to ozone. Conversely, when the compounded amount exceeds 2.5, the appearance is dramatically diminished. The compounded amount of the wax is more preferably from 1.0 to 2.0 parts by mass.

When the compounded amount of the polyalkyl methacrylate is less than 0.5 parts by mass, the compounded amount is too small, and the effect of the present technology cannot be achieved. Conversely, when the compounded amount exceeds 3 parts by mass, appearance flaws occur. The compounded amount of polyalkyl methacrylate is more preferably from 1.0 to 3.0 parts by mass.

When the compounded amount of the polybutene resin is less than 0.5 parts by mass, the compounded amount is too small, and the effect of the present technology cannot be achieved. Conversely, when the compounded amount exceeds 5.0 parts by mass, appearance flaws occur. The compounded amount of the polybutene resin is more preferably from 1.0 to 2.5 parts by mass.

When the molar ratio of the wax to the polybutene resin is less than 0.8 or greater than 3.2, the appearance is diminished.

Here, the number of moles of the wax in the present technology is the number of moles of the hydrocarbon contained in the greatest amount in the wax.

In addition to the aforementioned components, the rubber composition of the present technology can also include various types of additives that are commonly added in rubber compositions, such as vulcanizing and cross-linking agents, vulcanizing and cross-linking accelerators, fillers, antiaging agents, plasticizers, and the like. The additives may be kneaded and blended according to a general method and used in vulcanizing or cross-linking. The compounded amounts of these additives may be any conventional standard amount, so long as the object of the present technology is not hindered.

Additionally, the rubber composition of the present technology is preferably introduced into the side walls of a pneumatic tire in accordance with a conventional method for manufacturing pneumatic tires, as described above.

### EXAMPLES

The present technology is further explained in detail with reference to the working examples and comparative examples described hereinafter, but the present technology is not limited by these examples.

### Working Examples 1 to 19 and Comparative Examples 1 and 12

Preparation of Samples

After the components excluding the vulcanization accelerator and sulfur in the formulations (parts by mass) shown in Tables 1 and 2 were kneaded with a 1.7 liter sealed Banbury mixer for 5 minutes, the mixture was discharged from the mixer at approximately 150° C. and cooled to room temperature. Thereafter, the rubber composition was obtained adding the vulcanization accelerator and sulfur to the composition and kneading with an open roller. Next, the rubber composition thus obtained was vulcanized in a press with predetermined mold at 170° C. for 10 minutes to obtain a vulcanized rubber test sample, and the test methods described below were then used to measure the physical properties of the vulcanized rubber test sample.

Appearance: Evaluated visually in accordance with the following criteria, the test sample having been left to stand for two weeks in an oven at 40° C.

1 point: overall white discoloration

2 points: white discoloration of approximately 30% of the entire area

3 points: overall blotching

4 points: blotching of approximately 30% of the area.

5 points: unchanged

This was performed on 3 samples of each composition, and the average score was used as an evaluation score.

Tensile test: A tensile test was performed at room temperature in accordance with JIS K 6251 (JIS No. 3 dumbbell), and the tensile strength (TB) and elongation at break (EB) were measured. The results are shown as index values with Comparative Example 1 or 4 being 100. A larger index value indicates higher strength.

Ozone resistance: The ozone resistance was tested under test conditions according to JIS K6259 for 48 hours at 40% stretching, 50 pphm, and 40° C. and samples were evaluated visually under the following criteria.

1 point: cracks or cuts of 3 mm or greater

2 points: deep and large cracks (1 to 3 mm)

3 points: deep and comparatively large cracks (less than 1 mm)

4 points: although not confirmable with the naked eye, cracking or cutting can be confirmed using a magnifying glass (10×).

5 points: no cracking observed with the naked eye or using a magnifying glass (10×)

This was performed on 3 samples of each composition, and the average score was used as an evaluation score.

The results are shown in Tables 1 and 2.

TABLE 1

| | Working | Working | Working | Working | Working | Working | Working |
|---|---|---|---|---|---|---|---|
| | Example 1 | Example 2 | Example 3 | Example 4 | Example 5 | Example 6 | Example 7 |
| NR *1 | 40.00 | 40.00 | 40.00 | 40.00 | 40.00 | 40.00 | 40.00 |
| BR *2 | 60.00 | 60.00 | 60.00 | 60.00 | 60.00 | 60.00 | 60.00 |
| Carbon black *3 | 50.00 | 50.00 | 50.00 | 50.00 | 50.00 | 50.00 | 50.00 |
| Zinc oxide *4 | 3.00 | 3.00 | 3.00 | 3.00 | 3.00 | 3.00 | 3.00 |
| Stearic Acid *5 | 1.50 | 1.50 | 1.50 | 1.50 | 1.50 | 1.50 | 1.50 |
| Antiaging agent-1 *6 | 2.00 | 2.00 | 2.00 | 2.00 | 2.00 | 2.00 | 2.00 |
| Antiaging agent-2 *7 | 2.00 | 2.00 | 2.00 | 2.00 | 2.00 | 2.00 | 2.00 |
| Wax-1 *8 | 2.00 | 2.00 | 2.00 | 2.00 | — | — | 2.00 |
| Wax-2 *9 | — | — | — | — | 2.00 | 2.00 | — |
| Oil *10 | 10.00 | 10.00 | 10.00 | 10.00 | 10.00 | 10.00 | 10.00 |
| Vulcanization Accelerator *11 | 1.00 | 1.00 | 1.00 | 1.00 | 1.00 | 1.00 | 1.00 |
| Soluble sulfur *12 | 1.50 | 1.50 | 1.50 | 1.50 | 1.50 | 1.50 | 1.50 |
| Polyalkyl methacrylate *13 | 1.00 | 3.00 | — | — | 1.00 | 3.00 | |
| Polyalkyl methacrylate-2 *14 | — | — | — | — | — | — | 1.00 |
| Polyalkyl methacrylate-3 *15 | — | — | — | — | — | — | — |
| Polyalkyl methacrylate-4 *16 | — | — | 1.00 | 3.00 | — | — | — |
| Measurement results | | | | | | | |
| Appearance | 4.0 | 3.7 | 4.0 | 3.7 | 4.0 | 3.7 | 3.3 |
| TB | 101 | 103 | 100 | 105 | 101 | 103 | 99 |
| EB | 101 | 103 | 104 | 101 | 101 | 100 | 103 |
| Ozone resistance | 4.0 | 4.0 | 3.7 | 4.0 | 2.3 | 2.7 | 3.0 |

| | Working | Working | Working | Comparative | Comparative | Comparative |
|---|---|---|---|---|---|---|
| | Example 8 | Example 9 | Example 10 | Example 1 | Example 2 | Example 3 |
| NR *1 | 40.00 | 40.00 | 40.00 | 40.00 | 40.00 | 40.00 |
| BR *2 | 60.00 | 60.00 | 60.00 | 60.00 | 60.00 | 60.00 |
| Carbon black *3 | 50.00 | 50.00 | 50.00 | 50.00 | 50.00 | 50.00 |
| Zinc oxide *4 | 3.00 | 3.00 | 3.00 | 3.00 | 3.00 | 3.00 |
| Stearic Acid *5 | 1.50 | 1.50 | 1.50 | 1.50 | 1.50 | 1.50 |
| Antiaging agent-1 *6 | 2.00 | 2.00 | 2.00 | 2.00 | 2.00 | 2.00 |
| Antiaging agent-2 *7 | 2.00 | 2.00 | 2.00 | 2.00 | 2.00 | 2.00 |
| Wax-1 *8 | 2.00 | 2.00 | 2.00 | 2.00 | 2.00 | — |
| Wax-2 *9 | — | — | — | — | — | 2.00 |
| Oil *10 | 10.00 | 10.00 | 10.00 | 10.00 | 10.00 | 10.00 |
| Vulcanization Accelerator *11 | 1.00 | 1.00 | 1.00 | 1.00 | 1.00 | 1.00 |
| Soluble sulfur *12 | 1.50 | 1.50 | 1.50 | 1.50 | 1.50 | 1.50 |
| Polyalkyl methacrylate *13 | — | — | — | — | 5.00 | — |
| Polyalkyl methacrylate-2 *14 | 3.00 | — | — | — | — | — |
| Polyalkyl methacrylate-3 *15 | — | 1.00 | 3.00 | — | — | — |
| Polyalkyl methacrylate-4 *16 | — | — | — | — | — | — |
| Measurement results | | | | | | |
| Appearance | 2.7 | 3.0 | 2.3 | 1.3 | 1.0 | 2.7 |
| TB | 97 | 97 | 96 | 100 | 95 | 99 |
| EB | 106 | 104 | 103 | 100 | 98 | 105 |
| Ozone resistance | 3.3 | 3.3 | 3.0 | 3.7 | 4.0 | 1.7 |

TABLE 2

| | Working | Working | Working | Working | Working | Working | Working |
|---|---|---|---|---|---|---|---|
| | 11 | 12 | 13 | 14 | 15 | 16 | 17 |
| NR *1 | 40.00 | 40.00 | 40.00 | 40.00 | 40.00 | 40.00 | 40.00 |
| BR *2 | 60.00 | 60.00 | 60.00 | 60.00 | 60.00 | 60.00 | 60.00 |
| Carbon black *3 | 50.00 | 50.00 | 50.00 | 50.00 | 50.00 | 50.00 | 50.00 |
| Zinc oxide *4 | 3.00 | 3.00 | 3.00 | 3.00 | 3.00 | 3.00 | 3.00 |
| Stearic Acid *5 | 1.50 | 1.50 | 1.50 | 1.50 | 1.50 | 1.50 | 1.50 |
| Antiaging agent-1 *6 | 2.00 | 2.00 | 2.00 | 2.00 | 2.00 | 2.00 | 2.00 |
| Antiaging agent-2 *7 | 2.00 | 2.00 | 2.00 | 2.00 | 2.00 | 2.00 | 2.00 |
| Wax-1 *8 | 2.00 | 2.00 | 1.00 | 1.00 | 2.00 | 2.00 | 2.50 |
| Wax-2 *9 | — | — | — | — | — | — | — |
| Oil*10 | 10.00 | 10.00 | 10.00 | 10.00 | 10.00 | 10.00 | 10.00 |
| Vulcanization Accelerator *11 | 1.00 | 1.00 | 1.00 | 1.00 | 1.00 | 1.00 | 1.00 |
| Soluble sulfur *12 | 1.50 | 1.50 | 1.50 | 1.50 | 1.50 | 1.50 | 1.50 |
| Polybutene resin-1 *17 | 2.00 | 5.00 | 2.70 | 1.00 | — | — | 5.00 |
| Polybutene resin-2 *18 | — | — | — | — | 2.00 | 5.00 | — |
| Molar ratio | 2.18 | 0.87 | 0.81 | 2.18 | 3.11 | 1.24 | 1.09 |
| (wax/polybutene resin) | | | | | | | |
| Total compounded | 14.00 | 17.00 | 13.70 | 12.00 | 14.00 | 17.00 | 17.50 |
| amount of oil, wax, and | | | | | | | |
| polybutene resin (parts | | | | | | | |
| by mass) | | | | | | | |
| Measurement results | | | | | | | |
| Appearance | 4.3 | 4.0 | 4.3 | 4.7 | 4.0 | 4.0 | 3.3 |
| TB | 101 | 102 | 102 | 100 | 103 | 103 | 101 |
| EB | 101 | 105 | 101 | 105 | 103 | 104 | 107 |
| Ozone resistance | 5.0 | 4.7 | 5.0 | 4.3 | 4.3 | 4.3 | 4.7 |

| | Working | Working | Compar- | Compar- | Compar- | Compar- |
|---|---|---|---|---|---|---|
| | 18 | 19 | ative 4 | ative 5 | ative 6 | ative 7 |
| NR *1 | 40.00 | 40.00 | 40.00 | 40.00 | 40.00 | 40.00 |
| BR *2 | 60.00 | 60.00 | 60.00 | 60.00 | 60.00 | 60.00 |
| Carbon black *3 | 50.00 | 50.00 | 50.00 | 50.00 | 50.00 | 50.00 |
| Zinc oxide *4 | 3.00 | 3.00 | 3.00 | 3.00 | 3.00 | 3.00 |
| Stearic Acid *5 | 1.50 | 1.50 | 1.50 | 1.50 | 1.50 | 1.50 |
| Antiaging agent-1 *6 | 2.00 | 2.00 | 2.00 | 2.00 | 2.00 | 2.00 |
| Antiaging agent-2 *7 | 2.00 | 2.00 | 2.00 | 2.00 | 2.00 | 2.00 |
| Wax-1 *8 | — | — | 2.00 | 1.00 | 2.00 | 2.00 |
| Wax-2 *9 | 2.00 | 2.00 | — | — | — | — |
| Oil *10 | 10.00 | 10.00 | 10.00 | 10.00 | 10.00 | 10.00 |
| Vulcanization Accelerator *11 | 1.00 | 1.00 | 1.00 | 1.00 | 1.00 | 1.00 |
| Soluble sulfur * 12 | 1.50 | 1.50 | 1.50 | 1.50 | 1.50 | 1.50 |
| Polybutene resin-1 *17 | 1.00 | 3.50 | — | — | 7.50 | — |
| Polybutene resin-2 *18 | — | — | — | — | — | 7.50 |
| Molar ratio | 3.10 | 0.89 | — | — | 0.58 | 0.83 |
| (wax/polybutene resin) | | | | | | |
| Total compounded | 13.00 | 15.5 | 12.00 | 11.00 | 19.50 | 19.50 |
| amount of oil, wax, and | | | | | | |
| polybutene resin (parts | | | | | | |
| by mass) | | | | | | |
| Measurement results | | | | | | |
| Appearance | 4.3 | 4.0 | 1.3 | 1.7 | 1.3 | 1.0 |
| TB | 101 | 102 | 100 | 98 | 98 | 102 |
| EB | 101 | 105 | 100 | 104 | 102 | 95 |
| Ozone resistance | 3.7 | 3.7 | 4.0 | 2.3 | 4.3 | 3.7 |

| | Compar- | Compar- | Compar- | Compar- | Compar- |
|---|---|---|---|---|---|
| | ative 8 | ative 9 | ative 10 | ative 11 | ative 12 |
| NR *1 | 40.00 | 40.00 | 40.00 | 40.00 | 40.00 |
| BR *2 | 60.00 | 60.00 | 60.00 | 60.00 | 60.00 |
| Carbon black *3 | 50.00 | 50.00 | 50.00 | 50.00 | 50.00 |
| Zinc oxide *4 | 3.00 | 3.00 | 3.00 | 3.00 | 3.00 |
| Stearic Acid *5 | 1.50 | 1.50 | 1.50 | 1.50 | 1.50 |
| Antiaging agent-1 *6 | 2.00 | 2.00 | 2.00 | 2.00 | 2.00 |
| Antiaging agent-2 *7 | 2.00 | 2.00 | 2.00 | 2.00 | 2.00 |
| Wax-1 *8 | 1.00 | 1.00 | 2.00 | — | — |
| Wax-2 *9 | — | — | — | 2.00 | — |
| Oil *10 | 10.00 | 10.00 | 10.00 | 10.00 | 10.00 |
| Vulcanization Accelerator *11 | 1.00 | 1.00 | 1.00 | 1.00 | 1.00 |
| Soluble sulfur *12 | 1.50 | 1.50 | 1.50 | 1.50 | 1.50 |
| Polybutene resin-1 *17 | 5.00 | — | 1.00 | — | 5.00 |
| Polybutene resin-2 *18 | — | 5.00 | — | — | — |
| Molar ratio | 0.44 | 0.62 | 4.36 | — | — |
| (wax/polybutene resin) | | | | | |
| Total compounded | 16.00 | 16.00 | 13.00 | 12.00 | 15.00 |
| amount of oil, wax, and | | | | | |
| polybutene resin (parts | | | | | |
| by mass) | | | | | |
| Measurement results | | | | | |
| Appearance | 1.7 | 1.7 | 1.7 | 3.0 | 2.7 |
| TB | 102 | 99 | 99 | 101 | 99 |
| EB | 97 | 103 | 97 | 96 | 91 |
| Ozone resistance | 2.7 | 3.3 | 4.3 | 1.7 | 1.3 |

“Working” refers to working examples, and “Comparative” refers to comparative examples.

*1: NR (TSR20)

*2: BR (Nipol BR1220, manufactured by Zeon Corporation)

*3: Carbon black (Niteron#10S, manufactured by NSCC Carbon Co., Ltd.)

*4: Zinc oxide (Zinc Oxide #3, manufactured by Seido Chemical Industry Co., Ltd.)

*5: Stearic acid (Beads Stearic Acid YR, manufactured by NOF Corporation)

*6: Antiaging agent-1 (Santoflex 6PPD, manufactured by Flexsys)

*7: Antiaging agent-2 (Antigen RD-G, manufactured by Sumitomo Chemical Co., Ltd.)

*8: Wax-1 (SANNOC, manufactured by Ouchi Shinko Chemical Industrial Co., Ltd.; number of carbon atoms of hydrocarbon contained in the greatest amount determined by gas chromatography=32)

*9: Wax-2 (Hi-mac-1080 manufactured by Nippon Seiro Co., Ltd.;

number of carbon atoms of hydrocarbon contained in the greatest amount determined by gas chromatography=45)

*10: Oil (Diana Process Oil AH-20 manufactured by Idemitsu Kosan Co., Ltd.)

*11: Vulcanization accelerator (Noccelar CZ-G made by Ouchi Shinko Chemical Industrial Co., Ltd.)

*12: Sulfur (“Golden Flower” Oil Treated Sulfur Powder, manufactured by Tsurumi Chemical Industry Co., Ltd.)

*13: Polyalkyl methacrylate-1 (Aclube 132 manufactured by Sanyo Chemical Industries, Ltd.; weight average molecular weight=50,000; SP value 9.0)

*14: Polyalkyl methacrylate-2 (Aclube A1060 manufactured by Sanyo Chemical Industries, Ltd.; weight average molecular weight=50,000; SP value=9.4)

*15: Polyalkyl methacrylate-3 (Aclube C728 manufactured by Sanyo Chemical Industries, Ltd.; weight average molecular weight=50,000; SP value=9.5)

*16: Polyalkyl methacrylate-4 (Aclube V4130 manufactured by Sanyo Chemical Industries, Ltd.; weight average molecular weight=200,000; SP value=9.3)

*17: Polybutene resin-1 (HV-100 manufactured by JX Nippon Oil & Energy Corporation; weight average molecular weight=980)

*18: Polybutene resin-2 (HV-300 manufactured by JX Nippon Oil & Energy Corporation; weight average molecular weight=1,400)

As is clear from Table 1 above, the rubber compositions prepared in Working Examples 1 to 10 contain specific amounts of wax and specific amounts of a polyalkyl methacrylate mixed into rubber components of specific compositions and therefore prevent appearance flaws due to whitening and also have good ozone resistance in comparison to Comparative Example 1. In addition, it became clear that there are no adverse effects on the properties required of tire side walls. The ozone resistance is diminished slightly in Working Examples 5 and 6 since the number of carbon atoms of the hydrocarbon contained in the greatest amount in the wax exceeds 40. The TB and ozone resistance are diminished slightly in Working Examples 7 to 10 since the SP value of the polyalkyl methacrylate exceeds 9.3.

In contrast, the appearance was diminished in Comparative Example 2 since the compounded amount of the polyalkyl methacrylate exceeded the upper limit prescribed in the present technology.

The appearance and ozone resistance were diminished in Comparative Example 3 since polyalkyl methacrylate was not added.

As is clear from Table 2 above, the rubber compositions prepared in Working Examples 11 to 19 contain specific amounts of wax and specific amounts of polybutene resin mixed into rubber components of specific compositions, and the molar ratios of the waxes to the polybutene resins are set to specific ranges, so the compositions prevent appearance flaws due to whitening and also have good ozone resistance in comparison to Comparative Example 4. In addition, it became clear that there are no adverse effects on the properties required of tire side walls. The appearance is diminished slightly in Working Example 17 since the compounded amount of the oil, wax, and polybutene resin exceeds 17 parts by mass with respect to 100 parts by mass of the diene rubber. The ozone resistance is diminished slightly in Working Examples 18 and 19 since the number of carbon atoms of the hydrocarbon contained in the greatest amount in the wax exceeds 40.

In contrast, although the compounded amount of the wax is reduced in Comparative Example 5 in comparison to Comparative Example 1, neither the appearance nor the ozone resistance was improved.

The appearance was diminished in Comparative Example 6 since the compounded amount of the polybutene resin exceeded the upper limit prescribed in the present technology and the molar ratio of the wax to the polybutene resin was less than the lower limit prescribed in the present technology.

The appearance was diminished in Comparative Example 7 since the compounded amount of the polybutene resin exceeded the upper limit prescribed in the present technology.

The appearance was diminished in Comparative Examples 8 and 9 since the molar ratio of the wax to the polybutene resin was less than the lower limit prescribed in the present technology.

The appearance was diminished in Comparative Example 10 since the molar ratio of the wax to the polybutene resin exceeded the upper limit prescribed in the present technology.

The appearance and ozone resistance were diminished in Comparative Example 11 since a polybutene resin was not added.

The appearance and ozone resistance were diminished in Comparative Example 12 since a wax was not added.

What is claimed is:

1. A rubber composition having mixed therein from 1 to 2.5 parts by mass of a wax and a polyalkyl methacrylate or a polybutene resin with respect to 100 parts by mass of a diene rubber including a natural rubber;
the rubber composition comprising from 0.5 to 3 parts by mass of the polyalkyl methacrylate with respect to 100 parts by mass of the diene rubber including the natural rubber when the polyalkyl methacrylate is mixed therein;
the rubber composition comprising from 1.0 to 5.0 parts by mass of the polybutene resin with respect to 100 parts by mass of the diene rubber including the natural rubber when the polybutene resin is mixed therein, a molar ratio of the wax to the polybutene resin being in a range of from 0.8 to 3.2.

2. The rubber composition according to claim 1, wherein a weight average molecular weight of the polyalkyl methacrylate is from 10,000 to 200,000.

3. The rubber composition according to claim 1, wherein a number of carbon atoms of an alkyl portion of the polyalkyl methacrylate is from 1 to 20.

4. The rubber composition according to claim 1, wherein a number of carbon atoms of a hydrocarbon contained in a greatest amount in the wax is at most 40.

5. The rubber composition according to claim 1, wherein a compounded amount of the natural rubber is from 30 to 50 mass % with respect to the entire diene rubber.

6. The rubber composition according to claim 1, wherein an SP value of the polyalkyl methacrylate is at most 9.3.

7. The rubber composition according to claim 7, wherein an SP value of the polyalkyl methacrylate is from 8.7 to 9.0.

8. The rubber composition according to claim 1, wherein a compounded amount of the polyalkyl methacrylate is from 1.0 to 3.0 parts by mass with respect to 100 parts by mass of the diene rubber.

9. The rubber composition according to claim 1, wherein a weight average molecular weight of the polybutene resin is from 500 to 5,000.

10. The rubber composition according to claim 9, wherein a weight average molecular weight of the polybutene resin is from 500 to 2,000.

11. The rubber composition according to claim 1 having an oil further mixed into the rubber composition, wherein a compounded amount of the oil, the wax, and the polybutene resin is at most 17 parts by mass with respect to 100 parts by mass of the diene rubber.

12. The rubber composition according to claim 1, wherein a compounded amount of the polybutene resin is from 1.0 to 2.5 parts by mass with respect to 100 parts by mass of the diene rubber.

13. A pneumatic tire using the rubber composition described in claim 1 in side walls.
